(19) United States
(12) Patent Application Publication
(10) Pub. No.: US 2006/0224612 A1
(43) Pub. Date: Oct. 5, 2006

(54) Information processing system for a value-based system

(76) Inventors: Christopher Cowan, Santa Barbara, CA (US); Natasha Todorovic, Santa Barbara, CA (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/093,755

(22) Filed: Mar. 30, 2005

(51) Int. Cl. G06F 17/00

(52) U.S. Cl. 707/102

(57) ABSTRACT

Embodiments of the invention include an electronic processing system for determining states of existence for individuals or groups of individuals, or both. The system incorporates cognitive, psychological, and perceptual principles. The system includes a mechanism for obtaining input variables; one or more processors, a processing engine with one or more processing units for re-parameterizing input variables to graded category variables to accomplish functions such as human value characterization and grouping by similarities, a perceptual schema database, and an output generator that produces structured data.

### FIELD OF THE INVENTION

The invention described herein relates to an information processing system for a value-based system. The system characterizes individuals and groups of individuals.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to any software and data as described below and in the drawings that form a part of this document: Copyright 2005, Humergence, LLC. All Rights Reserved.

### BACKGROUND

In the mid-twentieth century, Clare W. Graves taught psychology at Union College in New York. There he developed an epistemological model of human psychology. He developed this model because he found himself unable to answer questions of his students concerning which psychology theorist was “correct” with respect to his or her model.

In an attempt to answer the students' questions, Graves developed a theory that he believed reconciled the approaches of understanding human psychology. He tested his theory over the years from about 1952 to 1959 by collecting data from his psychology students. His analysis of this data became the basis for his theory of “The Emergent Cyclical Levels of Existence Theory” (ECLET). In describing his theory, Dr. Graves stated, “The psychology of the mature human being is an unfolding, emergent, oscillating, spiraling process marked by progressive subordination of older, lower-order behavior systems to newer, higher-order systems as man's existential problems change.”

### SUMMARY

One embodiment of the invention described herein includes an electronic processing system for determining states of existence for individuals or groups of individuals, or both. The system incorporates cognitive, psychological, and perceptual principles. The system includes a mechanism for obtaining input variables; one or more processors, a processing engine with one or more processing units for re-parameterizing input variables to graded category variables to accomplish functions such as human value characterization and grouping by similarities. The system also includes a perceptual schema database, and an output generator that produces structured data.

Another embodiment of the invention includes computer readable media for structuring data, creating a data structure for describing the data obtained from a questionnaire having queries related to human values. The computer readable media orders numeric data that rank the query answers; linguistic data that describe the human values measured; indices that identify the data with each level of processing such as ordinate level within schema structure, perceptual schema, and human categorization. The computer readable media generates labels that associate the data with perceptual concepts.

Another embodiment of the invention includes a method of query processing in an electronic image retrieval system, comprising: receiving one or more query input describing queries in a human value based questionnaire in linguistic terms; translating the linguistic query input into a query value descriptor that conforms to the schema of claim 2; comparing the query image descriptor to the value descriptor of values stored in a database; and retrieving a value profile for an individual or a group with a value descriptor that most closely matches the query value descriptor.

One other embodiment of the invention includes a method of analyzing linguistic information comprising: an electronic spreadsheet that accepts digital images and their image descriptors as input to its cells; means for reading the data in the image descriptors; and formulas that operate on the data contained in the image descriptors.

### DEDSCRIPTION OF DRAWNGS

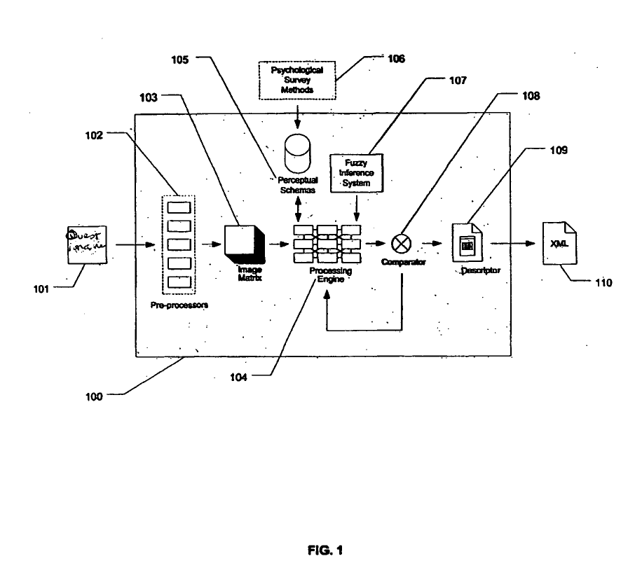

FIG. 1 illustrates a schematic view of one system embodiment of the invention described herein.

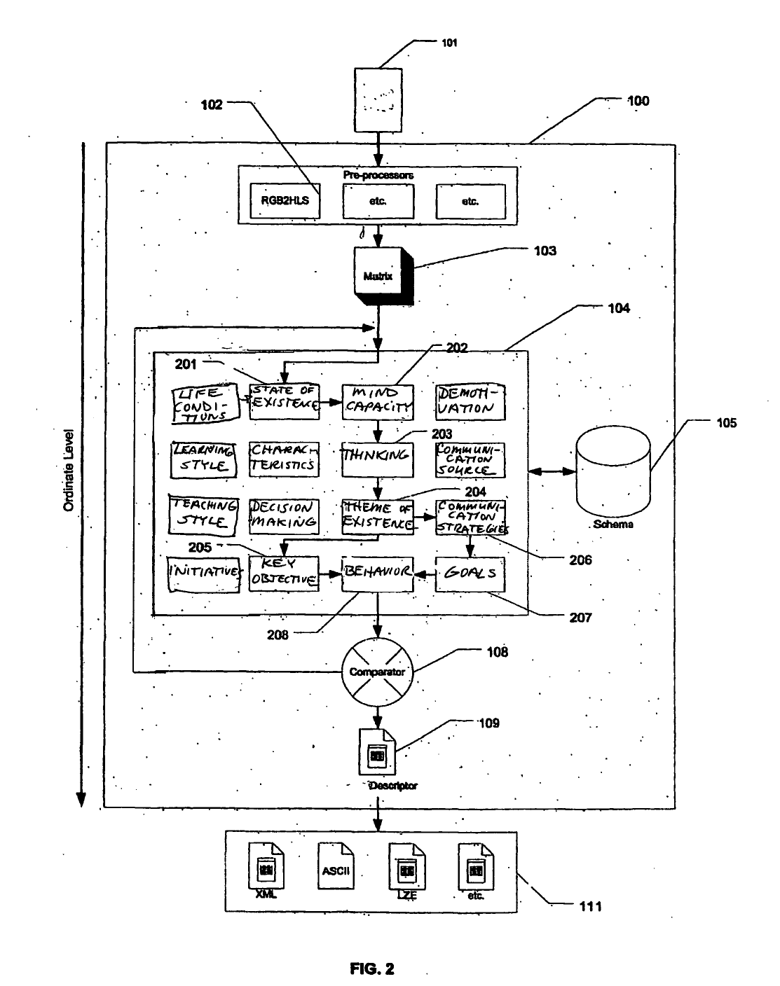

FIG. 2 illustrates a schematic view of one aspect of the system of FIG. 1.

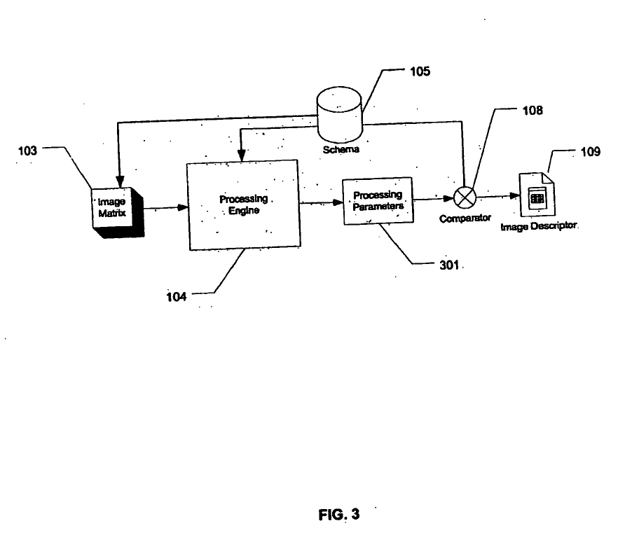

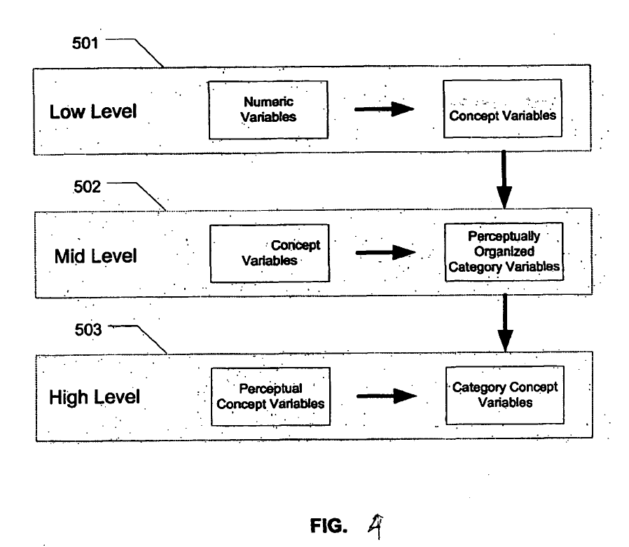

FIG. 3 and FIG. 4 illustrate processing for the system of FIG. 1.

### DETAILED DESCRIPTION

Methods, apparatus and systems for extraction of a variety of materials from biomass are described herein. In the following description, numerous specific details are set forth. However, it is understood that embodiments of the invention may be practiced without these specific details. In other instances, well-known circuits, processes, structures, and techniques have not been shown in detail in order to avoid obscuring the understanding of this description. Note that in the description, references to “one embodiment” or “an embodiment” mean that the feature being referred to is included in at least one embodiment of the invention. Further, separate references to “one embodiment” in this description do not necessarily refer to the same embodiment; however, neither such embodiments are mutually exclusive, unless so stated and except as will be readily apparent to those of ordinary skill in the art. Thus, the invention described herein may include any variety of combinations and/or integrations of the embodiments described herein. Moreover, in this description, the phrase “exemplary embodiment” means that the embodiment being referred to serves as an example or illustration.

1. Perceptual Schema and Graded Membership

A system embodiment of the invention is described herein for predicting how an individual human being or group of human beings will behave in one or more environments having a plurality of defined features. The system embodiments include a human value-based schema having a cognitive science element and a computer science element, the human value-based schema having a uniform structure when applied to either a single individual or to a group of individuals. Embodiments of the invention also include an expert system that includes a database of empirical psychological data; an array of algorithms for partitioning the database into human value groups; tags for tagging the psychological data with a human value group identification; and a report mechanism for generating a report that characterizes the human values of an individual or a group of individuals, and for some embodiments, analyzes and predicts how the individual or group of individuals will behave in one or more environments having a plurality of defined features. By “behave” it is meant how the individual or group of individuals interact with others and how the individual or group of individuals engage in decision making.

In cognitive sciences, a cognitive schema is a mental framework for organizing-knowledge, thereby creating a meaningful structure of related concepts. Schemas organize knowledge into categories having varying degrees of abstraction. Schemas relate concepts, identify attributes within concepts as well as attributes in related concepts, identify concepts and particular context, identify specific concepts and general background knowledge, and causality. The cognitive schema is characterized in linguistic terms with fuzzy definition.

In computer science, a computer schema is a structured framework used to describe the structure of a database or document. A computer schema is used to define tables, fields, and other attributes of a database as well as attributes and types of data elements in a document. The variables described in a computer schema are generally represented by numeric values.

Embodiments of the invention described herein include a value-based schema, which includes computer schema that incorporates a hierarchical categorization structure based upon hypotheses regarding human value systems, with super-ordinate categories, primary value-based or cognitive attributes, and specific cognitive attributes coded at different levels of the schema. In the described embodiment, the perceptual schema employs fuzzy variables, in particular, linguistic variables, to substitute graded category or group membership values for numeric values.

2. Uniform Schema Structure

Embodiments of the invention described herein employ a value-based schema structure for analyzing the value systems of individuals as well as groups of individuals. In one described embodiment, each level of the system contains schema with a common structural organization that includes standardized data elements. This organization allows for a modular, flexible, and extensible architecture such that each processing unit may receive input from any other processing unit. Each processing unit organizes its input/output as a composite fuzzy query tree in a schema. Some input and output embodiments employ the same schema structure. Furthermore, all processing units are organized to fit together within the system according to a schema structure. Finally, the resulting description of the value system for an individual or a group of individuals employs the same schema structure. The uniform schema structure described herein includes a plurality of categories wherein each category includes a collection of predictable human behaviors and characterizations. The uniform schema structure also includes a plurality of conditions, capabilities, and styles that are predicted for each category of the plurality of predictable human behaviors and characterizations.

3. Expert Knowledge

Embodiments of the invention described herein use data derived from psychological survey methods for determining a human value category structure, in particular, primary category designation, super-ordinate, and sub-ordinate structure, to construct schemas that incorporate expert human knowledge regarding the human value category structure. These psychological survey methods include measurements based upon linguistic variables to determine primary versus super-ordinate designation; survey methods to measure typicality, which in turn can be used to determine primary, super-ordinate, and sub-ordinate relations; and interpersonal interaction studies to determine primary human value-based category status. The hierarchical schema structure of embodiments of the invention described herein provides super-ordinate, primary, and sub-ordinate levels that support these human cognitive schemas. Included in structure are primary, super-ordinate and sub-ordinate forms of change that enable an individual or a group of individuals to move among different portions of the hierarchical schema structure.

In one embodiment, the human value category structure is shown in Table 1:

TABLE 1

| Level of | | Nature of | |
|---|---|---|---|
| Existence | State | Existence | Problems of Existence |
| Second Being | HU | Experientialistic | Accepting Existential |
| | | | Dichotomies |
| First Being | GT | Cognitive | Restoring Viability to a |
| | | | Disordered World |
| Sixth Subsistence | FS | Sociocentric | Living with the human |
| | | | element |
| Fifth Subsistence | ER | Materialistic | Conquering the physical |
| | | | universe so as to overcome |
| | | | want |
| Fourth | DQ | Saintly | Achieving everlasting piece |
| subsistence | | | of mind |
| Third Subsistence | CP | Egocentric | Living with Self Awareness |
| Second | BO | Tribalistic | Achievement of relative |
| Subsistence | | | safety |
| First Subsistence | AN | Automatic | Maintaining physiological |
| | | | stability |

In one embodiment, expert knowledge based schema are characterized for each of these variables: life conditions, mind capacities, thinking, theme of existence, characteristics, decision making, motivation, demotivators, communication source, communication strategies, key objective, how to accomplish goals, mission statement, approach to working, learning style and teaching style. The characterization for each schema is performed for individuals and groups of individuals through linguistic based testing for some embodiments, image and optionally audio based testing for other embodiments, and a combination one or more of linguistic, visual, and audio testing for other embodiments.

The testing is performed by posing a plurality of queries to an individual through an electronic medium. In one embodiment, the electronic medium is web-enabled using the World Wide Web. For some embodiments, an individual's answers to a set of queries prompts another set of questions so that two individuals may answer different sets of questions. For other embodiments, the two individuals answer the same set of questions, as do all other individuals taking the test. In another embodiment, the individual selects one of a group of possible answers. The answer selected by the individual to a first question, categorizes the individual into one or more of the collections of predictable human behavior and characterizations, but not to all of the possible collections. The answer selected by the individual to the second question may remove one of the collections selected as a result of the answer selected for the first question. Additional questions further narrow the collections that best characterize the individual. At the end of answer selection by the individual and analysis of answers, one collection of predictable human behaviors, beliefs, motivators and characterizations is identified. In one embodiment, each of the collections of predictable human behavior and characterization are nuanced so that the collection has a spectrum of behavior within it. Answers selected by the individual further characterize the individual within the collection of predictable human behavior.

In one embodiment, questions are tagged in accordance with the human category being addressed by the question. The tag is used to determine the value system of the individual or a group of individuals.

One collection of human behavior and characterizations is designated as “AN.” For the AN or first subsistence collection, the life condition is that “the world is a state of nature.” The mind capacity is to “express self to satisfy immediate, periodic, psychological.” The thinking is “instinctive.” The theme of existence is “express self as if just another animal according to the dictates of one's imperative physiological needs and the environmental possibilities.” The characteristics are “survival/meeting biological needs/instinctive drives and urges.” The decision making is immediate and sensory based. The motivators are “offer food, water; sex input through basic senses; touch (if safe); caress to give reassurance; recognize the intelligences which are there.” The demotivators are to “withdraw food or make threatening moves; cause physical pain or discomfort through temperature; thirst; treat as animal-like being.” The communication source is caretaker and provider. The communication strategy is based upon biologic senses such as touch, taste, smell, sight, hearing; physical contact rather than language or symbols. The learning style is based upon instincts, habituation, and even activation of genetic memories. The teaching style is by varying the intensity of stimulation such as touch, sound, and taste. The behavior is motivated only by imperative periodic physiologic needs such as hunger and sleep. Individuals in this collection seek individual bodily function stability through automatic responses. They have no concept of time, distance, causality, or awareness of self.

The BO state of existence has a life condition which is a mysterious world with hidden forces, spirits and lives that are both benevolent and malicious. The mind capacity is to deny self to placate spirits, remove fear, find relative safety in a secure, protective group, and live according to traditions and ancient ways. The thinking is animistic. The theme of existence is to sacrifice one's desires to the ways of one's elders. The characteristics of someone with a BO personality are related to a belief in mystical spirits, safety in clans and nests, powerful elders, “our people versus them” and kinship and blood ties. Decision-making is custom and tradition, Elder's counsel, signs or the shaman. The clan gets the spoils and honors through ancestral ways. Demotivators for individuals in the BO group include speaking ill of the chief or tribe; stepping on or desecrating sacred grounds; violating taboos or ritual ways; introducing ambiguity; isolating and forcing accelerated change and uncertainty; disrespecting elders or ancestors and “don't try to understand.” The communication source for individuals having a BO type of personality are caring chieftain and/or shaman; counsel from the revered elders; from within the tribe/clan group; signals and omens from spirit realm; word of ancestors and their ways and recognizing blood-bonds, the folk, the group. Communication strategies for individuals having a BO type personality are through traditional rites, rituals, ceremonies; including mystical elements and superstitions; appeals to wise man, shaman, chief, tribal leader; relates through commonalities with the past; familiar metaphors, drawings and emblems; minimal reliance on written language. The key objective of an individual or a group having BO traits is just staying alive. Goals are accomplished by finding safety and protection.

Another state of existence is a “CP” state, or egocentric state. For individuals having a CP personality, life conditions are tough, rough, unpredictable. The world is full of risk, danger, dominance, deceit, submission and control, as well as adventure. The mind capacity for these individuals is one of self awareness that is born to give rise to express the self. Their attitude is “to heck with anyone else so as to be the toughest, strongest and most heroic—the attitude is impulsive. The thinking of individuals having a CP personality is egocentric. The theme of existence is to express self and “to hell with others lest one suffer the torment of unbearable shame.” The characteristics of the CP personality include raw power displays, immediate pleasure, unrestrained by guilt. CP personalities are colorful and creative, egocentric and tough. Decision making is that the tough one dictates. Whatever gets respect is a proper decision. What feels good now; power grab spoils; thinking is guiltless and short term. Motivators include immediate payoffs, macho appeals, challenges, and dares; heroic images, more clout and personal power; looking good and getting due respect; gaining control over nature and other people; getting by with something; prizes and rewards NOW. Demotivators include challenges to power or courage; shame or put down of a person or group; moves onto turf uninvited; display of more powerful weapons; making gestures and name-calling; being derisive and laughing; causing one to lose face; taunting as an outsider; appearing or talking weak; making excuses. Communication sources include a person with recognized power and status; celebrated idol with a reputation; straight-talking Big Boss; one with something to offer; someone respected, revered, feared; someone with proven trustworthiness. The communication strategies include these: do not philosophize—stick to concrete, immediate responses; demonstrate “what's in it for me—now.” Ensure immediate gratification if flashy to the point; strong heroic status and legendary potential; hands on demonstration—show and do; do not punish, preach or sermonize. The key objective of the CP personality is being unique, exerting dominance. Goals are accomplished by exploiting others, avoiding guilt, feeling guilt, being courageous, avoiding shame. The mission statement for individuals and groups with a CP personality is to get quick cash and have a good time. The approach to working is hands on, tough work controlled by firm, respected boss. The learning style is operant conditioning which is impaired by punishment; heroic tales; trial and error; reward and reinforcement. The teaching style is patient, immediate rewards; DO NOT PUNISH; tough and strong; variety; hands-on; high activity level. The behavior is avoidant—refusal to respond; rough, loud, assertive language; frequent blasts of hostility; extreme sensitivity to external controls; negative resistance to authority; attributing malevolent purpose or intent to others; all or nothing responses; self protective so as not to be shamed; simplistic solutions; centrality of life is respect and aggression, reactive responses to defend the self against criticism; impulsivity in responses.

Another state of existence is a DQ or saintly existence. Life conditions for a DQ personality are that inequality and inequity exist in a world full of unbridled lusts, endless struggle and a threatening universe which tests humans to do right; mortality (awareness). The mind capacities include denying self earthly, bodily and selfish desired to prove self as worthy and to achieve everlasting peace and reward in later life; seek, protection and deal with guilt. The thinking of a DQ personality is absolutistic. The theme of existence sacrifice self now to receive reward later. Characteristics of the DQ personality are that there is only one right way; purposes in causes; guilt in consequences; sacrifices for honor; absolutistic truths; decision-making is made by orders from authority; do right—obey rules; adhere to tradition; righteous earn spoils; follow procedures. Motivators include duty, honor, country; semper fi; righteousness; obedience to higher authority; being prepared; sacrifice and discipline; rewards for dedication to come in the afterlife; stability/order; purpose; standards and norms; finding greater meaning; being a good citizen; and functionality. Demotivators for the DQ personality include attacks on religion, country, or ethnic heritage; symbol desecration or Holy Books; put down the One True Way or make fun of it; violate chain of command; disregard rules and directives; appear unfair or sleazy; be wishy-washy; use “bad” language; demean the standards, be late. The communication source must have a high status and prestige although expertise is not important; rightful proper authority; down the chain of command; according to the book's rules and regulations; person with position and rank; compliance to norms and rules for behavior.

Communication strategies include finding out who is the proper authority; going through the right channels and finding the appropriate content. Strategies also include appealing to traditions, laws and established norms; use class consciousness and knowing one's place; propriety, righteousness and responsibilities; conveying proper behavior and delayed gratification; assuaging guilt with correct consequences.

The key objective of a DQ personality is to maintain stability, order, and salvation. Goals are accomplished by seeking absolute truth, obeying higher authority, keeping things in order. The mission statement of a DQ personality is to earn security and do God's will. The approach to working is linear processing by the book with errors punished. The learning style is avoidant; through rightful and proper authority with status and prestige; seeking absolute truth; absorbing facts. The teaching style is instructivist and authoritarian; punishment (of the right kind, in the right amount, from the right source) of undesired activities; no punishment equals no learning; too much punishment equals rigid learning; memorization; structured; repetitive.

Behavior of a DQ personality accepts prescriptions of higher power without question; tests of worthiness to deserve peace in afterlife; absolute obeisance to rightful higher authority; filled with should's and ought's and must's; guilt is centralized as a theme of existence; absolutistic; categorical, rigid, dogmatic, redundant, accept what is not to change or doubt rightful authority. Maturity is prescribed according to a known universal order commandments, directives, must's and ought's, redundancy and repetition in thoughts; categorical and judgmental; seeking peace and contentment (don't be surprised by existential jargon in nodal DQ) like people but wish they were better; idealization of authority and rules, God, duty, honor, country, parents absolutism; should/ought; black/white; either/or; categorical authoritarian submission character structure; centrality of authority; double standard based on status and prestige (allow behavior in people of higher status; damn it in those of lower place); responses interpret the world in terms of “oughtness”; rules should be obeyed and followed.

Another state of existence is the ER or materialistic state. The life conditions of the ER state include a potentially abundant world with opportunities for wealth, knowledge=doge, advancement and satisfaction of wants and desires. The mind capacities include testing options and finding ways to gain control over the physical universe; expressing self but not arousing the ire of important others. The thinking is multiplistic; the theme of existence is “express self for what self desires, but in a fashion calculated not to bring down the wrath of others.”

The characteristics of an ER personality include competing for success, goal oriented drives; change to progress; material gain/perks; seeks personal growth. The decision making is based upon bottom line results; testing options for the best option; consulting experts, successful win spoils; relying upon experience.

Motivators include opportunities to succeed; progress, growth, winning, achievement, making things better; competitive edge and advantages; bigger and better, new and improved; state of the art; fashionable; prevailing through experience, calculated risks and good science; cutting edge; making deals and bargains, treating like a VIP.

Demotivators include put down profit or entrepreneurism; talk about collectivization; accusation of games and demean outcomes; challenge compulsive drives; deny rewards for good performance; force sameness; cost prestige; trap with rules and procedures; fail to bargain or negotiate; seem inflexible; treat as one of the herd; seem ordinary. Communication sources must have succeeded in the same area and have high status and prestige; make it their idea and advantageous; model successful mentors and role models; credible professionals and “gurus”; prosperous, successful, elite contacts; tried and true experience, experimentation.

Communication strategies include communication through a knowledgeable expert without authority who represents the authority; appeal to competitive advantage and leverage; success motivations and achieving abundance; bigger, better, newer, faster, more popular; citations of experts and selected authorities; experimental data and tried and true experience.

The key objective of an ER personality is success and material gain. This objective is accomplished by striving to win, making things better now, risking as needed, networking. The mission statement is to achieve goals and win at the game. The approach to working is competing to gain advantage and to make new things better. The learning style is expectancy, constructivist, independent, impaired by authority. The teaching style is to provide experiential opportunities to learn through one's own efforts—control of learning; engaging in learning experience; supportive, reciprocal relationship; warm and down to earth; coaching; knowledgeable amateur; providing mild risk, comparison and variety; individual recognition.

The ER personality is a quiet negative element; critical; negation, snide; cynical; resists outside control; negative to authority more modulated than CP; tends to want to show anger; but moderated; tends to evaluate without immediate hostile words present; negation; tentative consideration before acceptance; beginning tendency to think in alternative ways; multiplistic—look at things in more than one way, but decisions about how to see it is determined by what is best for self; self interest. See parents, rules, authority, laws as restrictive but necessary, not malevolent; snide, cynical, smart mouthed, critical; uses words to cut others up; negates the idea of a proper way to live; tolerance of ambiguity—enough information to work from. Believes the information to work from. Believes the information for solutions can be gathered up: “If I could be free to take things over I could clear things up.” Makes decisions alone; centrality of life is mine own self interest; will hold onto own conclusion despite evidence to the contrary.

The FS state of existence is sociocentric. Life conditions of the FS personality include living with the human element since material ends produce an internal void and an external world angry with the byproducts of over consumption. Mind capacities include belonging and being accepted, denying self now so self and others might have now, and human harmony can come to be; balance. Thinking is interpersonalistic.

The theme of existence is, “sacrifice now in order to get acceptance now and so all may have now.” Individuals with an FS personality seek inner peace; believe everybody is equal; everything is relative; harmony in the group; seeks consciousness. The decision making occurs by reaching consensus. All must collaborate; accept any nut; communalize spoils; work for harmony.

The theme of existence is participation and involvement; consensus decisions; teamwork; liberation of the oppressed; sharing; acceptance of human weakness and foibles; openness; environmental sensitivity; tolerance; political correctness; inclusion; social responsibility and awareness; participation; corporate citizenship and community involvement.

Demotivators include assaulting the group's goals and ideals; trying to get centralized control; dividing the group; rejecting the collective for individual accountability; supporting aggressive competition; denying affect and feelings; degrading quality of life or environment; appearing cold blooded, appearing mercenary; relying upon hard facts to the exclusion of people factors; acting elitist or exclusive.

The communication source must be through the community, enlightened friend or colleague; source must have expertise and knowledge, high status or prestige but not both; observation of events here and now; responsive to feelings/emotions/process; relative to situation and people at hand. Communication strategies for FS personalities include features of being honest, up front and open—do not hide anything, act superior, or manipulate others; sensitive to human issues and care for others; expand awareness and understanding of inner self; focus on equity, humanity, and bonding; build trust, openness, exploration, passages; real people and authenticate displays.

The key objective of the FS personality is affiliation and peace of mind. Goals are accomplished by sacrifice for mutual gain, sharing, cooperation to build consensus. The mission statement is finding peace in a sharing community. The approach to working is cooperation in joint ventures where all can contribute. The learning style of an FS personality is sociocentric, collaborative, vicarious, modeling, observational learning; impaired by competitiveness and authority. The teaching style is teaching by varying the intensity of stimulation like toughness, sound and taste.

The behavior of the FS personality is relativistic—situationalistic and context-dependent, re-entry of spirituality; many alternatives and each to his own; many alternatives—choice made on the basis of feeling and knowledge or rules—service to others; considers intellectually but conclusion does not always follow logic; show negative sensitivity to control by authority; sensitive to peer group and situation; feedback delivered in a way to lead to change; “each to his own; others have their way, we have ours, not mine to judge.” Chameleon-like character; “when I FEEL this way I do thus.” Control is necessary but not to hurt people; centrality of life is people and friends; superficial approach to solving problems of the world—they go away; showing negativity around only one thing—hurting other people. “Things should be different but I'm not the one to change them.”

A GT state of existence is cognitive. Life conditions for a GT personality are that the world is in danger of collapse; use and misuse of the planet and its resources puts all life in jeopardy; scarcity. The mind capacities include expressing self without doing harm to others or the planet; seeking self respect and restoration of the world so all life can continue. The thinking of a GT personality is systemic. The theme of existence is “express self for what self desires but never at the expense of others or environment, and in a manner that all life, not just my life, will profit.”

The characteristics of the GT personality include big picture views; integrative structures; naturalness of chaos; inevitability of change; seeks to learn more. The decision making is highly principled; knowledge centered; resolves paradoxes; competence rewarded; depersonalized. The motivators include liberation and being and doing as one chooses; learning interesting things to enhance quality of being; access to diversity in people, choices, and big picture views; enhancing competency and functionality; principles and what's right; tries to produce in appropriate and sustainable ways; demonstrates linkages and interconnections.

Demotivators include forcing rules without reasons; imposing dysfunctional structure; focusing on minor details; being punitive; denying individual control of time; making work repetitive; closing access to varied information or learning resources; trying to homogenize; knowingly harming people or the environment; passing the puck to the future; forcing groupness; ignoring diversity of thinking. Communication sources include any useful information source with expertise; competent, more knowing person/entity; relevant, more functional data; merging formal sources and hunches; individualized explorations and discoveries; media congruent with message.

Communication strategies include honest, up front and open—do not hide anything, act superior, or manipulate others; interactive, relevant media self accessible; functional “lean” information without fluff. The facts, feelings and the instincts; connect data across fields for holistic view. The key objective is knowledge seeking and being independent.

Goals are accomplished by learning diverse things, following personal principles and being flexible. The mission statement is being free and learning interesting things. The approach to working is an independent focus on living systems and functionality. The learning style of a GT personality is multidimensional; integrative; open to many sources; eclectic. The teaching style is to pose problems; provide different ways to see many answers; leave conclusions to individual's creativity; provide resources when required; honesty and openness; being reserved with praise. Reluctant to judge; chameleon-like character. Other categories of human existence are further discussed in a book entitled Levels of Human Existence, Transcription of a Seminar at the Washington School of Psychiatry Oct. 16, 1971 (2000), which is herein incorporated by reference.

4. Adaptively Driven Human Value-Processing Sub-Algorithms

Some embodiments of the invention described herein include a dynamic causal system with processing units that use variables and parameters that have been updated according to the conditions of the previous processing cycle. These embodiments are used to determine whether an individual or a group of individuals are moving from one level of existence to another. These embodiments are also used to determine whether an individual's state of existence is a hybrid of one or more of the states of existence described above. At each level of processing, a processing unit may introduce adjustment to variables in the schema. These variable adjustments allow the system to adapt results from earlier processing cycles. This adaptation process makes the system both temporally and contextually causal, allowing for a flexible, responsive dynamical system. In one embodiment, the dynamic causal system uses default variables and parameters defined in the schema during the initial processing cycle, adjusting them in the process, and uses the modified values in each subsequent processing cycles. The system then determines whether an individual is characterized by a particular level of existence and the predisposition of the individual to transition to a different level of existence.

5. Standardized Tag for Value-Based Categorization

Some embodiments of the invention described herein include a standardized data descriptor that maps labels to uniquely defined human value structures, such as are shown in FIG. 2. The descriptor describes the metadata of a human value structure file and tags value aggregates with perceptual labels easily understood by human beings. The perceptual labels are defined according to the levels of existence and other value-based psychology, which allows humans to naturally infer context. The descriptor functions with incomplete information and/or default information. As with alpha-numeric data, these descriptor tags may be manipulated and operated upon for specific purposes. The descriptor may be implemented in a number of formats including as ASCII text file, XML, SGML, and proprietary format. In one embodiment, the descriptor is implemented in XML to allow easy data exchange and facilitate application transparency and portability.

Embodiments of the invention described herein include a system for human value-based information processing, that automatically codes linguistically obtained value-based profiles, image obtained value-based profiles and audio obtained value based profiles for easy processing, labeling, describing, organizing, retrieving, recognizing, and manipulating. The system integrates research from diverse and separate disciplines including cognitive science, non-linear dynamic systems, soft computing, perceptual organization, and psychological principles. One embodiment of the system allows automatic coding of linguistic queries, obtained from questionnaires prepared by applicants, image-based queries, video queries, and audio queries into a human value-based map. Another embodiment of the system employs visual images and automatically codes the visual images into the human value-based map. The coding extends the utility and value of a human value-based map by allowing new applications to be created for management and employment of these human value-based tags efficiently, intelligently, and intuitively. Embodiments include websites accessible on the World Wide Web for polling political preferences, other value-related preferences, and measuring value systems of national populations, regional populations, genders, and virtually any other grouping of human beings.

Embodiments of the invention described herein are also usable to predict how an individual will act when hired by a company. For this embodiment, employees of the company are tested using one or more of the testing methods described herein. Analysis of the test results for each employee is compared to every other employee in order to determine the level of existence for the company, as defined by categories described herein and by hybrids of these catagories. The individual is then tested and his or her values are characterized and compared to the level of existence for the company.

For instance, employees in a company may be found to have a largely materialistic existence. A prospective employee may be found to have a saintly value-based system. If the company employees to not have any saintly attributes, system embodiments of the invention predict that the prospective employee will not be successful in the company and will not be able to assist the company in achieving its goals. This type of testing may be performed to enable an individual to determine his or her suitability to enter a particular profession or attend a particular school.

For other embodiments, marketers may use system embodiments of the invention to target a pre-selected audience with greater precision. The marketers create messages to attract individuals at a level of existence such as a materialistic level.

In another embodiment, a statistically significant sampling of a population may be tested to determine the level of existence of a particular country. Companies and governments may use this information to formulate strategies for negotiating with individuals in the countries.

For other embodiments, behaviorists may use the system of the invention to change the behavior of a preselected group of individuals. With this embodiment, the level of existence of the target group of preselected individuals is determined. As discussed, the determination is made by asking a series of questions that may be in writing, imagery or audio or a combination of these options. The behaviorists then determine the state of existence that an individual or a group of individuals must have in order to behave in a desired manner. The behaviorists then determine how to accomplish a change in the state of existence for the individuals.

FIG. 1 illustrates a human value perceptual information processing system 100 according to one embodiment. The system accepts as input an array of queries and answers to a questionnaire 101. The array of queries and answers to the questionnaire 101 is processed by processors 102 which transform the array into a matrix 103 where the location of queries m and answers n corresponds to the location queries and answers of a questionnaire 101. The matrix 103 encodes the queries and answers of the questionnaire 101.

For some embodiments, the matrix 103 is then processed by a processing engine 104. The processing engine 104 is, for some embodiments, modular in design, with multiple processing units connected both in series and in parallel to drive various processes. Each processing unit contains one or more processors, schema, and one or more parameters that feed back to the processors. Each processing unit implements algorithms to perform a specific function. For some embodiments, not all processing units are employed in processing a task. The specific processing units employed may change depending on task requirements. The processing units implement algorithms designed to re-parameterize input to produce a categorical output.

The processing engine 104 interacts with the value based and computer based schemas 105 to obtain data to perform specific functions and to update the values stored in the schemas. The value based schemas 105 are constructed with data derived from value based organization, psychology, and human category data obtained through psychological survey methods 106 such as typicality measurements, relative category ordinate designation, value based and perceptual prototype.

Some embodiments of the schema and processing units employ fuzzy variables, which are linguistic variables that substitute graded membership for numeric values. The processing engine 104 employs a fuzzy inference system 107 to process and update schema values. The use of fuzzy logic circumvents conventional requirements for precise measurements. The use of fuzzy inference enables characterization of states of existence that are hybrids of one or more of the states of existence described above.

Viewed as a network, each processing unit corresponds to a node. On a computational level, each node represents a query with an initial uncategorized state and a series of question/answer pairs. Fuzzy inference system is employed to apply heuristics to interpret the query. The overall pattern of node activity represents both knowledge about human value-based systems and perceptual hypothesis. In this way, a question/answer path through the network automatically selects the processes best suited to process a questionnaire at a particular point according to its relation to the context at that point. The node outputs modify schema values and processor parameters such that the processing loop resets the parameters for the next processing cycle in a context dependent manner, enabling local processing decisions based on previous human value-based input, knowledge about human values, and global context.

For one embodiment, at the completion of each processing cycle, a comparator 108 compares the schema values to predefined completion criteria for the task and directs the system to either continue processing with updated parameters or to produce a descriptor 109 for the questionnaire 101 accordingly. The descriptor 109 encodes the properties of the questionnaire, the queries and answers, within the perceptual schema. For some embodiments, the descriptor 109 is described with an Extensible Markup Language (XML) document 110 to allow easy data exchange and facilitate application transparency and portability.

FIG. 2 illustrates one processing flow embodiment. After being processed by the pre-processors 102, the matrix 103 is passed to the processing engine 104. Each processing unit within the processing engine 104 consists of algorithms to perform a specific function. These algorithms may be implemented using fuzzy logic and objected-oriented computer language such as C or C++. Each processing unit is associated with a schema that defines the elements and attributes used to process the value-based matrix 103 in that unit. The processing units provide feedback to the system by adjusting the schema values and parameters.

According to this example, the matrix 103 is processed by a processing unit 201, that utilizes the expert schema described above to categorize personality into states of existence and which re-parameterizes the matrix 103 into prototypical value based categories that correspond to fuzzy sets within the value-based name universe of discourse. The output from the processing unit 201 is mapped to the universe of discourse representing states of human existence. For example, the processing unit 201 processes answers to a questionnaire in order to categorize the individual with respect to the variables shown in FIG. 2, such as “Life Conditions,” “Mind Capacity,” and so forth. The categorizations are compared to predetermined categorizations for the states of existence and a determination is made as to the closest match. The descriptor provides a report regarding a value based profile for the individual answering questions in the questionnaire.

At the completion of the processing, the system produces a Human Values descriptor 109 which describes individuals and groups of individuals based on perceptual organization. The Human Values descriptor 109 may be translated into other formats such as ASCII, XML, or proprietary formats for use in indexing, categorization, searching, manipulation, recognition, etc., as well as serve as input to other systems designed for specific applications.

FIG. 3 illustrates the adaptive processing strategy and the causal nature of the system. The processing parameters 301 are predefined with default values at the beginning of processing. Each processing unit within the processing engine 104 performs a function and returns a parameter adjustment. At the end of a processing cycle the comparator 108 updates the parameter with adjustments. These adjusted parameters are then used in the next processing cycle. In this manner, the system implements a context dependent processing strategy.

FIG. 4 illustrates how the system re-parameterizes information into category and concept variables. Some embodiments of the questionnaire 101 contain numeric values which are manipulated by the pre-processors 102 described above. For some embodiments, low level processing 501 maps these numeric variables to appropriate sensory fuzzy linguistic variables. Mid-level processing 502 accepts linguistic variables that reside in the sensory universe of discourse and re-parameterize it to perceptual organization variables “animistic, sacrifice now to receive reward later and so forth”. Mid-level processing 502, for some embodiments, implements a Gestalt psychology principle of the sum of the psychological and behavioral variables is larger than its parts. For some embodiments, high-level processing 503 accepts perceptually organized concept variables and return category variables which in turn form the basis for Artificial Intelligence (A.I.) tasks, such as personality type recognition. The processing path is not fixed. High-level processing units may accept input from low-level and mid-level processing units. High-level processing units, which process global context, however, may only affect low-level processing units through adaptive parameter adjustments in the next processing cycle.

### CONCLUSION

The invention described herein discloses a technology platform for a broad range of applications concerning human values. The platform and the data structure allow creation of new applications such as a spreadsheet software for managing and manipulating human value information, annotation software for labeling of human value categories, software useful in improving the productivity of organizations based upon a characterization of the values of each member of the organization and values of the organization as a whole, software for Human Values search, etc. The platform, further allows creation of expert systems for Human Value characterization and knowledge perception.

The foregoing description of embodiments of the invention has been presented for the purpose of illustration and description. What is described herein is not intended to be exhaustive or to limit the invention to the precise form disclosed.

What is claimed is:

1. An electronic processing system for determining states of existence for individuals or groups of individuals, or both, the system incorporating cognitive, psychological, and perceptual principles, the system comprising a mechanism for obtaining input variables; one or more processors, a processing engine with one or more processing units for re-parameterizing input variables to graded category variables to accomplish functions such as human value characterization and grouping by similarities, a perceptual schema database, and an output generator that produces structured data.

2. The electronic processing system of claim 1 wherein the mechanism for obtaining input variables is a questionnaire.

3. The electronic processing system of claim 1 wherein the mechanism for obtaining input variables captures a response to an audio query.

4. The electronic processing system of claim 1 wherein the mechanism for obtaining input variables captures a response to a visual query.

5. The system of claim 1, wherein the processing units comprise algorithms and mechanisms that re-parameterize input variables which correspond to value-based attributes to concept variables corresponding to perceptual principles, and cognitive and psychological prototypes.

6. The system of claim 1, wherein the system processes linguistic data in an adaptive fashion, with the processing unit making adjustments to the data in the schema.

7. The system of claim 1, wherein data derived by psychological survey methods, including identification of typicality metrics, prototypes, relative ordinate designation, and relative context within a data structure, are used to determine the compatibility of an individual in an organization.

8. The System of claim 1, wherein data derived by psychological survey methods, including identification of typicality metrics, prototypes, relative ordinate designation, and relative context within a data structure, are used to determine negotiation strategies.

9. The System of claim 1, wherein data derived by psychological survey methods, including identification of typicality metrics, prototypes, relative ordinate designation, and relative context within a data structure, are used to change behavior of an individual or a group of individuals.

10. The System of claim 1, wherein data derived by psychological survey methods, including identification of typicality metrics, prototypes, relative ordinate designation, and relative context within a data structure, are used to predict behavior of an individual or a group of individuals.

11. The system of claim 1, wherein numerical data are re-parameterized into linguistic category data and organized within a perceptual schema and an image descriptor.

12. The system of claim 1, wherein a fuzzy perceptual inference system is employed to transform numeric data into linguistic data.

13. The system of claim 12, wherein data derived by psychological survey methods including typicality survey is employed to construct schemas that incorporate expert human knowledge.

14. Computer readable media for ordering a data structure for describing the data obtained from a questionnaire having queries related to human values, the data structure comprising:
numeric data that rank the query answers; linguistic data that describe the human values measured;
indices that identify the data with each level of processing such as ordinate level within schema structure, perceptual schema, and human categorization; and
labels that associate the data with perceptual concepts.

15. A method of query processing in an electronic image retrieval system, comprising:
receiving one or more query input describing queries in a human value based questionnaire in linguistic terms;
translating the linguistic query input into a query value descriptor that conforms to the schema of claim 2;
comparing the query image descriptor to the value descriptor of values stored in a database; and
retrieving a value profile for an individual or a group with a value descriptor that most closely matches the query value descriptor.

16. A method of analyzing linguistic information comprising: an electronic spreadsheet that accepts digital images and their image descriptors as input to its cells; means for reading the data in the image descriptors; and formulas that operate on the data contained in the image descriptors.
